(19) United States
(12) Patent Application Publication
(10) Pub. No.: US 2013/0039223 A1
(43) Pub. Date: Feb. 14, 2013

(54) CALL CONNECTING METHOD AND SYSTEM BASED ON MOBILE VoIP

(71) Applicants: In Young PARK, Seongnam-Si (KR); Jong Hoon Lee, Suwon-Si (KR)

(72) Inventors: In Young PARK, Seongnam-Si (KR); Jong Hoon Lee, Suwon-Si (KR)

(73) Assignee: Xener Systems Inc., Seoul (KR)

(21) Appl. No.: 13/571,000

(22) Filed: Aug. 9, 2012

(30) Foreign Application Priority Data
Aug. 11, 2011 (KR) 10-2011-0080107
Jul. 12, 2012 (KR) 10-2012-0076050

(51) Int. Cl. H04W 4/00; H04L 12/16

(52) U.S. Cl. 370/259

(57) ABSTRACT

Provided is a call connecting system and method based on mobile Voice over Internet Protocol (mVoIP). The method of connecting a call based on mVoIP performed in the system for connecting a call based on mVoIP including a subscriber server and a call processing apparatus may include the subscriber server receiving a call connection request to a second user terminal from a first user terminal and providing notification of the received call connection request to the second user terminal, the call processing apparatus receiving a call attempt message from the first user terminal, the call processing apparatus receiving a call waiting notification, providing notification of a ready state from the second user terminal, and the call processing apparatus establishing a call connection between the first user terminal and the second user terminal by transmitting the received call attempt message to the second user terminal.

### CROSS-REFERENCE TO RELATED APPLICATIONS

This application claims priority from and the benefit of Korean Patent Application Nos. 10-2011-0080107, filed on Aug. 11, 2011, and 10-2012-0076050, filed on Jul. 12, 2012, both of which are hereby incorporated by reference for all purposes as if fully set forth herein.

### BACKGROUND OF THE INVENTION

1. Field of the Invention

Exemplary embodiments of the present invention relate to a call connecting method and system based on mobile Voice over Internet Protocol (mVoIP).

2. Discussion of the Background

Voice over Internet Protocol (VoIP) refers to a technology for voice communication via a network using an Internet Protocol (IP) address, involving converting a voice into a digital packet as a minimum data transmission unit.

Recently, with the development of a mobile Internet through smart phones and the like, use of mobile VoIP (mVoIP), an extension to a VoIP network to provide mobility, is on the rise. mVoIP enables a mobile phone to make a call via a wireless mobile Internet network, for example, wireless fidelity (Wi-Fi), a wireless local area network (WLAN), a third generation (3G) network, and the like. In spite of having a lower transmission rate than VoIP, a number of subscribers using mVoIP is increasing with the spread of smart phones and the like.

mVoIP subscribers may execute a registration procedure periodically on a call processing apparatus to maintain continuity of a service, so that the subscribers may transmit respective states of the subscribers to the call processing apparatus to receive an incoming call.

Generally, a VoIP subscriber call processing apparatus is designed under an assumption that a concentration ratio is in a range between about 10:1 and about 20:1. That is, one in ten or one in twenty subscribers may be in a busy state at a given moment. In this case, traffic for processing registration into a service is insignificant when compared to call processing traffic or an amount of computing power required for traffic processing.

However, mVoIP has an estimated concentration ratio of about 1000:1 or more. In this case, a load for processing registration into a service greatly exceeds a call processing load and thus, may affect system performance as a whole. Also, it may be difficult to manage a call processing capacity sufficiently when a number of subscribers is increasing at a rapid rate.

A call flow according to a related art is shown in FIG. 1. Referring to FIG. 1, a call connection is established between a first user terminal and a second user terminal through a call processing apparatus, and in this instance, a periodic registration procedure is required for call connection between users, as described in the foregoing. For call connection, a first user may execute registration of user information in a register on the call processing apparatus periodically in operation 101, and a second user also may execute registration of user information in a register on the call processing apparatus periodically in operation 102. The first user may correspond to the first user terminal and the second user may correspond to the second user terminal.

In the case of the first user being a caller and the second user a called party, a call connection is substantially established by the call processing apparatus receiving a call attempt from the first user in operation 103, finding the second user using called party information in operation 104, and transmitting the call attempt request to the second user in operation 105. This may be achieved because the call processing apparatus on which the first user and the second user execute a registration procedure is provided with user information.

When the second user receives the call attempt request from the first user, the second user may transmit a response to the call processing apparatus in operation 106. A call connection may be established between the first user and the second user in operation 107. The call processing apparatus may receive an acknowledgement (ACK) signal indicating that the call connection is completed without a data error in operation 108, and may transmit the ACK signal to the second user in operation 109.

### SUMMARY OF THE INVENTION

Exemplary embodiments of the present invention provide a call connecting method and system based on mobile Voice over Internet Protocol (mVoIP) that may ease the processing of traffic for executing a registration procedure periodically for continuity of a service, and may resolve issues associated with traffic, a processing capacity, and security caused by use of a session initiation protocol (SIP) for VoIP.

Exemplary embodiments of the present invention also provide a call connecting method and system based on mVoIP that may maintain a transmission control protocol (TCP) connection between a user terminal and a server through a separate channel and may use a separately defined message, based on the fact that most of services requiring mVoIP, for example, a mobile instant messaging (MIM) service, a social networking service (SNS), and the like, have a function for executing a registration procedure identical or similar to that of VoIP through an existing channel for transmitting information to subscribers.

Additional features of the invention will be set forth in the description which follows, and in part will be apparent from the description, or may be learned by practice of the invention.

An exemplary embodiment of the present invention discloses a method of connecting a call based on mVoIP performed in a system for connecting a call based on mVoIP comprising a subscriber server and a call processing apparatus, the method including receiving a call connection request to a second user terminal, by the subscriber server, from a first user terminal and providing notification of the received call connection request to the second user terminal, receiving a call attempt message, by the call processing apparatus, from the first user terminal, receiving a call waiting notification, by the call processing apparatus, providing notification of a ready state from the second user terminal, and establishing, by the call processing apparatus, a call connection between the first user terminal and the second user terminal by transmitting the received call attempt message to the second user terminal.

The transmitting of the call attempt message may be deferred until the call waiting notification providing notification of the ready state from the second user terminal is received by the call processing apparatus.

The notification of the call connection request may be provided to a user participating in the call connection through a separate channel, other than a call processing channel of the call connecting method, and user information may be absent in the call processing apparatus.

The separate channel may include an MIM service and an SNS, and may be connected to the user.

Another exemplary embodiment of the present invention discloses a method of connecting a call based on mVoIP performed in a system for connecting a call based on mVoIP comprising a subscriber server and a call processing apparatus, the method including receiving a call connection request to a second user terminal, by the subscriber server, from a first user terminal and transmitting a response to the received call connection request, receiving a call attempt message, by the call processing apparatus, from the first user terminal, and establishing, by the call processing apparatus, a call connection between the first user terminal and the second user terminal by transmitting the received call attempt message to the second user terminal.

In a case in which the first user terminal is an mVoIP subscriber and the second user terminal is a non-mVoIP subscriber, the receiving of the call connection request to the second user terminal, by the subscriber server, from the first user terminal and transmitting the response to the received call connection request may include transmitting to the first user terminal, by the subscriber server, a response message indicating that the second user terminal is a non-subscriber, in response to the received call connection request, and the call connection may be established by connecting the second user terminal to a public switched telephone network/public land mobile network (PSTN/PLMN).

The transmitting of the received call attempt message, by the call processing apparatus, to the second user terminal may include transmitting, by the call processing apparatus, the received call attempt message by connecting to the PSTN/PLMN through routing by using a telephone number of the second user terminal.

Still another exemplary embodiment of the present invention discloses a method of connecting a call based on mVoIP performed in a system for connecting a call based on mVoIP comprising a subscriber server and a call processing apparatus, the method including receiving a call attempt message, by the call processing apparatus, also routed using an identification number of an mVoIP subscriber through an interconnecting device, receiving a call connection request, by the subscriber server, from the call processing apparatus, receiving a call waiting notification, by the call processing apparatus, providing notification of a ready state from the second user terminal, and establishing, by the call processing apparatus, a call connection between the first user terminal and the second user terminal by transmitting the received call attempt message to the second user terminal.

In a case in which the first user terminal is a non-mVoIP subscriber and the second user terminal is an mVoIP subscriber, the receiving of the call connection request, by the subscriber server, from the call processing apparatus may include receiving the call connection request, by the subscriber server, from the call processing apparatus using information about the second user terminal.

The transmitting of the received call attempt message may be deferred until the call waiting notification providing notification of the ready state from the second user terminal is received by the call processing apparatus.

Yet another exemplary embodiment of the present invention discloses a system for connecting a call based on mVoIP including a subscriber server and a call processing apparatus, and the subscriber server may receive, from a first user terminal, a call connection request to a second user terminal and may provide notification of the received call connection request to the second user terminal, and the call processing apparatus may receive a call attempt message from the first user terminal, may receive a call waiting notification providing notification of a ready state from the second user terminal, and may establish a call connection between the first user terminal and the second user terminal by transmitting the received call attempt message to the second user terminal.

Further another exemplary embodiment of the present invention discloses a system for connecting a call based on mVoIP including a subscriber server and a call processing apparatus, and the subscriber server may receive, from a first user terminal, a call connection request to a second user terminal and may transmit a response to the received call connection request, and the call processing apparatus may receive a call attempt message from the first user terminal, and may establish a call connection between the first user terminal and the second user terminal by transmitting the received call attempt message to the second user terminal.

Still another exemplary embodiment of the present invention discloses a system for connecting a call based on mVoIP including a subscriber server and a call processing apparatus, and the call processing apparatus may receive a call attempt message also routed using an identification number of an mVoIP subscriber through an interconnecting device, the subscriber server may receive a call connection request from the call processing apparatus, the call processing apparatus may receive a call waiting notification providing notification of a ready state from the second user terminal, and the call processing apparatus may establish a call connection between the first user terminal and the second user terminal by transmitting the received call attempt message to the second user terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a signal processing flow based on a Voice over Internet Protocol (VoIP) according to a related art.

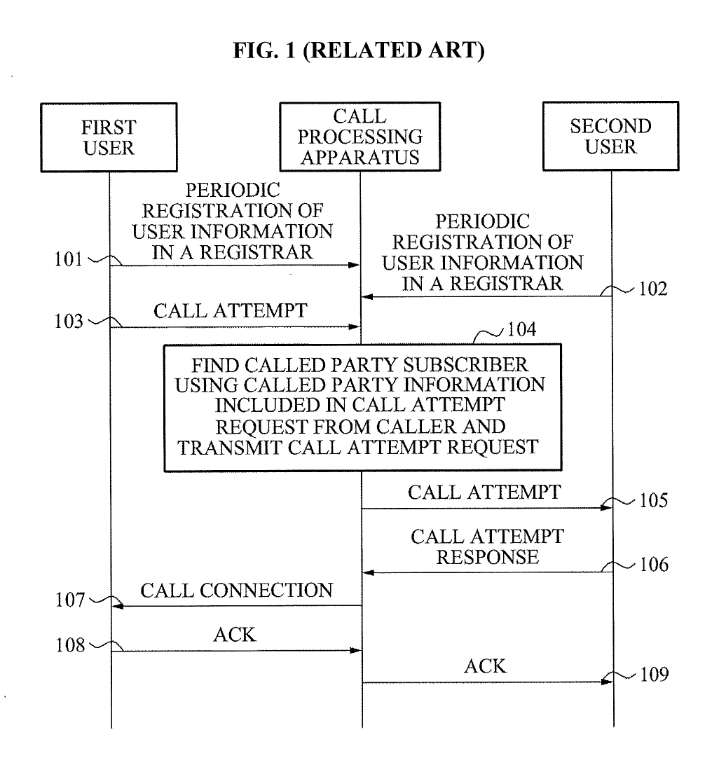

FIG. 2 is a diagram illustrating a configuration and an operation of a subscriber server of a system for connecting a call based on mobile VoIP (mVoIP) according to an exemplary embodiment of the present invention.

FIG. 3 is a diagram illustrating a call connecting method performed in a system for connecting a call based on an mVoIP according to an exemplary embodiment of the present invention.

FIG. 4 is a diagram illustrating a call connecting method performed in a system for connecting a call based on an mVoIP according to another exemplary embodiment of the present invention.

FIG. 5 is a diagram illustrating a call connecting method performed in a system for connecting a call based on an mVoIP according to still another exemplary embodiment of the present invention.

FIG. 6 is a diagram illustrating the system of FIG. 3.

FIG. 7 is a diagram illustrating the system of FIG. 4.

FIG. 8 is a diagram illustrating the system of FIG. 5.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

Exemplary embodiments provide a method and system for connecting a call based on mobile Voice over Internet Protocol (mVoIP).

Conventionally, signal processing based on VoIP is executed by a call processing apparatus acting as an intermediary between a caller and a called party. VoIP subscribers may be provided with a service by executing a procedure for registering user information in a register and updating on the call processing apparatus for continuity of a call originating and receiving service. Even though a user does not attempt a call, the user needs to execute an unnecessary procedure to receive an incoming call.

Also, use of a session initiation protocol (SIP) for VoIP may generate a load on traffic or a processing capacity, and may result in poor security since the SIP is a publicly known protocol.

To resolve these issues, the exemplary embodiments of the present invention may maintain a transmission control protocol (TCP) connection between a user terminal and a server through a separate channel without periodic SIP registration and updating, and may use a separately defined message, for example, a binary encoded message, as a type of a message transmitted and received between a user terminal and a server. Accordingly, a size may be reduced and security may be improved due to use of a dedicated message type.

According to the exemplary embodiments of the present invention, the call connecting system may include a subscriber server as well as a call processing apparatus to provide a VoIP service continuously without periodic registration of user information in a register executed by a user terminal.

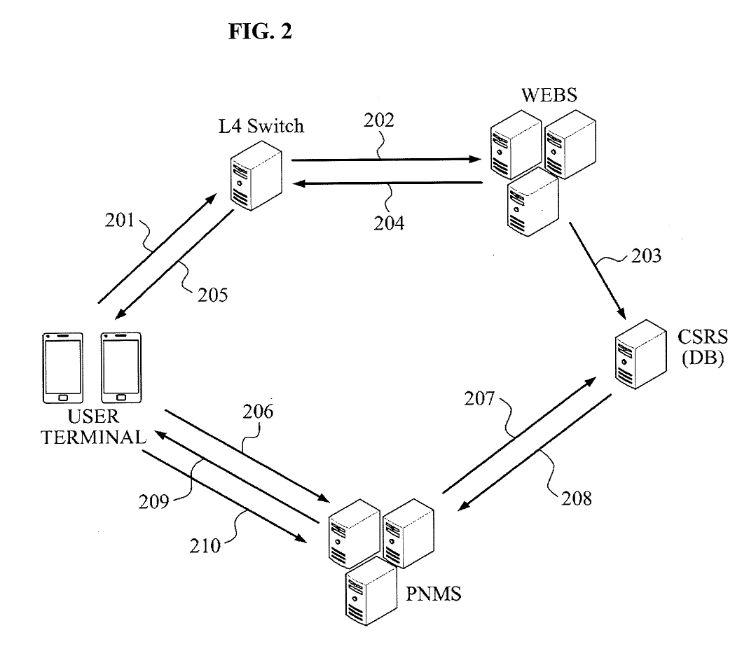

FIG. 2 illustrates a configuration and an operation of a subscriber server according to an exemplary embodiment of the present invention. The mVoIP subscriber server may have three functions; a first function for processing registration of a user terminal of an initial subscriber, a second function for maintaining a channel with the registered user terminal, and a third function for processing a call, processing a call attempt request for call connection, and transmitting a call request notification to a called party. To provide these three functions, the subscriber server may be configured as an internal function server as shown in FIG. 2. Hereinafter, a detailed description is provided in an operational order of each server.

In operation 201, the user terminal may transmit a registration request, and in operation 202, an L4 switch may receive the registration request and may distribute and transmit the received registration request to a web server-based web person search (WEPS). In operation 203, the WEPS may process the registration request or registration release request from the user terminal, and the registration request or registration release request may be transmitted in a form of a hypertext transfer protocol (HTTP)-based message. Since the WEPS is based on a web server, the WEPS may be extended with an increasing number of users. The user information processed for registration or registration release by the WEPS may be stored in and managed by a call server redirection server (CSRS) in an organized manner. Also, the WEPS may transmit a response to the request to the L4 switch to report the registration or registration release processed result to the user in operation 204, and the L4 switch may transmit the received response to the user terminal in operation 205. In this instance, the response may include push server information and call server information.

When the user terminal receives the response to the registration request or registration release request, the user terminal may request a push notification managing server (PNMS) to set up a TCP channel as well as an authentication request in operation 206. The PNMS may set up the channel with the user terminal and may maintain the channel using a keep message indicating that the user terminal is in such an active state to access a network, alive. The PNMS may be also extended with an increasing number of users.

In response to the authentication request, the PNMS may request the CSRS storing the user information to authenticate the user terminal in operation 207, and may receive an authentication result in operation 208. Also, the PNMS may transmit the authentication result and a response to the channel setup request to the user terminal in operation 209. The user terminal may complete registration and authentication so that the user terminal may use an mVoIP service.

Also, as described in the foregoing, to maintain the channel, that is, to notify that the user terminal is an active state in real time, the user terminal may transmit a request to the PNMS to keep the message alive and receive a response to the request from the PNMS periodically in operation 210.

In this instance, a call attempt and a call connection induced by the call attempt is executed through the call processing apparatus. However, prior to the call attempt being executed, within the subscriber server, the CSRS may transmit a response to the call request to the user terminal call transmitting the call request when the CSRS receives a call request from a user terminal, and may provide notification of the call request to the PNMS providing notification of the call request to a called party user terminal.

According to an exemplary embodiment, a method of connecting a call based on mVoIP may be performed in the system for connecting a call based on mVoIP, including the subscriber server and the call processing apparatus. The method may include the subscriber server receiving a call connection request to a second user terminal from a first user terminal, providing notification of the received call connection request to the second user terminal, the call processing apparatus receiving a call attempt message from the first user terminal, the call processing apparatus receiving a call waiting notification, providing notification of a ready state from the second user terminal, and the call processing apparatus establishing a call connection between the first user terminal and the second user terminal by transmitting the received call attempt message to the second user terminal. In this method, the operations between the user terminal and the call connecting system may be performed via wireless communication.

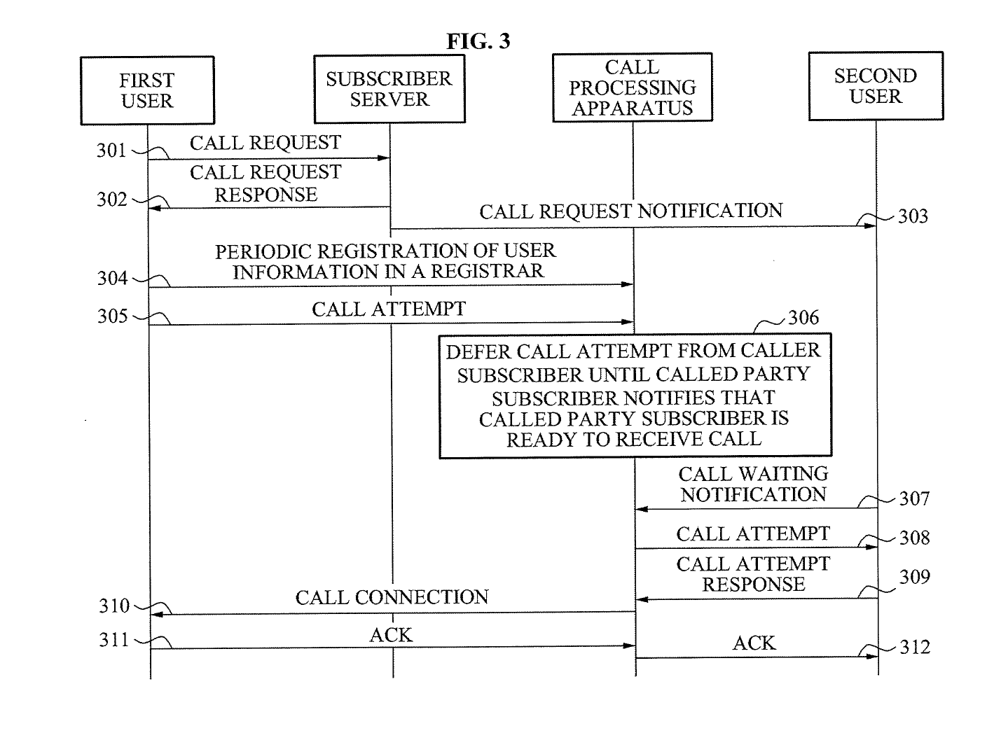

FIG. 3 illustrates each operation of the method of connecting a call on mVoIP performed in the system for connecting a call based on mVoIP, in a sequential manner. The first user terminal and the second user terminal may correspond to user terminals of the system for which registration and authentication are completed, and may enable a call connection between users, for example, mobile phones and the like. The first user terminal may be a caller and the second user terminal may be a called party. In FIG. 3, a call request may correspond to a call connection request, and a call attempt and a call attempt message may be interchangeably used herein.

As described in the foregoing, the subscriber server may receive a call request from the first user terminal in operation 301, may respond to the received call request in operation 302, and may provide notification of the call request transmitted from the first user terminal to the second user terminal in operation 303. As described in the foregoing, since registration and authentication for the first user terminal and the second user terminal are completed, the first user terminal and the second user terminal may transmit and receive the call request through the subscriber server. For a significant call connection between the first user terminal and the second user terminal, the first user terminal may execute registration of information a minimum number of times necessary for call attempt in operation 304. In operation 305, the call processing apparatus may receive the call attempt from the first user terminal by transmitting a response to the registration of user information in a register to the first user terminal. The call attempt may be transmitted in a form of a message. In operation 306, the call processing apparatus may defer transmitting the call attempt to the second user terminal until the call processing apparatus receives a call waiting notification providing notification of a ready state from the second user terminal, that is, until a called party subscriber notifies that the called party is ready to receive the call, in operation 307. The call waiting notification of the second user terminal may be received by the call processing apparatus verifying the registration of user information in a register of the second user terminal.

When the call processing apparatus verifies the call waiting notification of the second user terminal, the call processing apparatus may transmit the deferred call attempt to the second user terminal in operation 308, and may receive a response to the call attempt from the second user terminal in operation 309. The call processing apparatus may establish a call connection between the first user terminal and the second user terminal in operation 310. The call processing apparatus may receive, from the first user terminal, an acknowledge (ACK) signal indicating that the call connection is completed without a data error in operation 311, and may transmit the ACK signal to the second user terminal in operation 312.

The call connecting method according this exemplary embodiment may provide notification of the call request to a user participating in call connection through a separate channel other than an existing call processing channel, and user information may be absent in the call processing apparatus. The separate channel may include a mobile instant messaging (MIM) service and a social networking service (SNS). Also, the separate channel may include a channel connected to the user to provide the user with a service.

According to another exemplary embodiment, a method of connecting a call based on mVoIP may be performed in a system for connecting a call based on mVoIP including a subscriber server and a call processing apparatus. The method may include the subscriber server receiving a call connection request to a second user terminal from a first user terminal, transmitting a response to the received call connection request, the call processing apparatus may receive a call attempt message from the first user terminal, and the call processing apparatus establishing a call connection between the first user terminal and the second user terminal by transmitting the received call attempt message to the second user terminal.

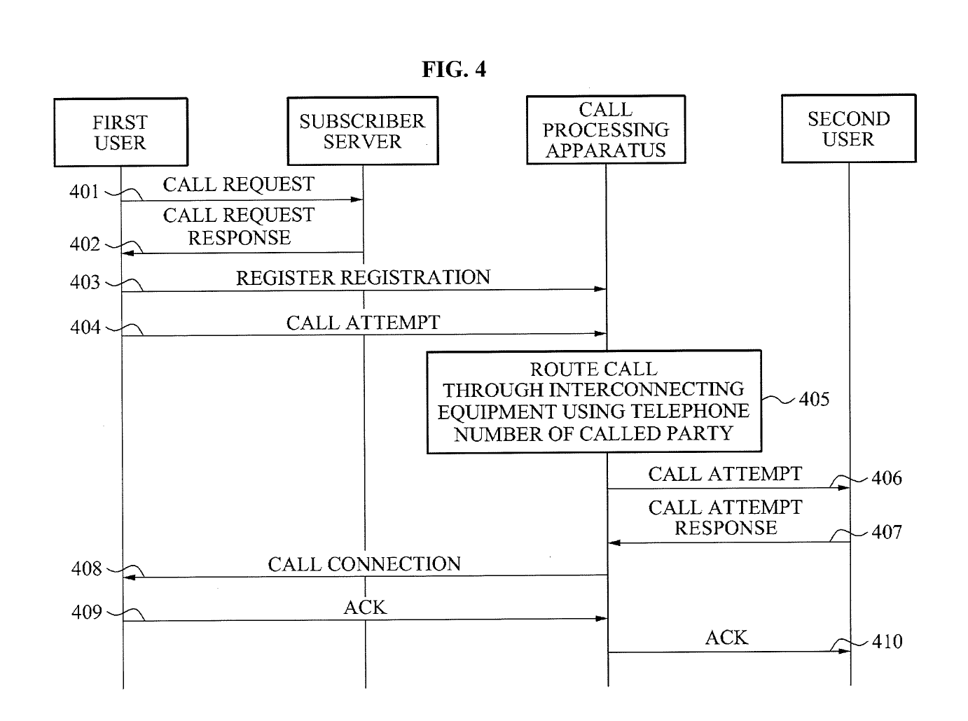

The call connecting method according to this exemplary embodiment is described with reference to a FIG. 4, and may be applied to a case in which the first user terminal is an mVoIP subscriber and the second user terminal is a non-mVoIP subscriber. When the subscriber server receives the call connection request to the second user terminal from the first user terminal and transmits the response to the call connection request, the subscriber server may transmit a response message, in response to the received call connection request, to the first user terminal indicating that the second user terminal is a non-subscriber and the call connection may be established by connecting the second user terminal to an external communication network, for example, a public switched telephone network/public land mobile network (PSTN/PLMN).

Hereinafter, a detailed description is provided in operational order with reference to FIG. 4. Similar to FIG. 3, the subscriber server may receive a call request to a second user terminal from a first user terminal in operation 401, and may transmit a response to the call request to the first user terminal in operation 402. In this instance, the transmitting of the response to the call request may include transmitting a response message to the first user terminal indicating that the second user terminal is a non-subscriber. Since the second user terminal is a non-subscriber, the subscriber server may eliminate an operation of providing notification of the call request received from the first user terminal to the second user terminal.

The first user terminal may execute registration of user information in a register to the call processing apparatus in operation 403, and may execute a call attempt in operation 404. The call processing apparatus may receive the call attempt in a form of a message from the first user terminal and may transmit the call attempt message to the second user terminal as a called party in operation 406. When the call processing apparatus transmits the call attempt message to the second user terminal, the call processing apparatus may transmit the call attempt message by connecting to an external communication network, for example, PSTN/PLMN, using a separate interconnecting device through routing by using a telephone number of the second user terminal in operation 405. That is, a call connection may be established between the first user terminal and the second user terminal via a separate interconnecting device, for example, a softswitch (SSW).

When the second user terminal receives the call attempt from the call processing apparatus through the interconnecting device, the second user terminal may transmit a response to the call attempt message in operation 407. When the call processing apparatus receives the response to call attempt from the second user terminal, the call processing apparatus may establish a call connection between the first user terminal and the second user terminal in operation 408. The call connection to the second user terminal may be established through an interconnecting device. Similar to FIG. 3, the call processing apparatus may receive, from the first user terminal, an ACK signal indicating that the call connection is completed without a data error in operation 409, and may transmit the ACK signal to the second user terminal in operation 410.

The call connecting method according to this exemplary embodiment may allow a call connection with a wired communication subscriber as well as a mobile communication subscriber since the method is based on a relatively low-cost mVoIP, in lieu of a costly mobile communication, using a telephone number of a user.

According to still another exemplary embodiment, a method of connecting a call based on mVoIP may be performed in a system for connecting a call based on mVoIP including a subscriber server and a call processing apparatus. The method may include the call processing apparatus receiving a call attempt message also routed using an identification number of an mVoIP subscriber through an interconnecting device, the subscriber server receiving a call connection request from the call processing apparatus, the call processing apparatus receiving a call waiting notification providing notification of a ready state from the second user terminal, and the call processing apparatus establishing a call connection between the first user terminal and the second user terminal by transmitting the received call attempt message to the second user terminal.

The call connecting method according to this exemplary embodiment may be applied to a case in which the first user terminal is a non-mVoIP subscriber and the second user terminal is an mVoIP subscriber, and when the subscriber server receives the call connection request from the call processing apparatus, the subscriber server may receive the call connection request from the call processing apparatus using information about the second user terminal.

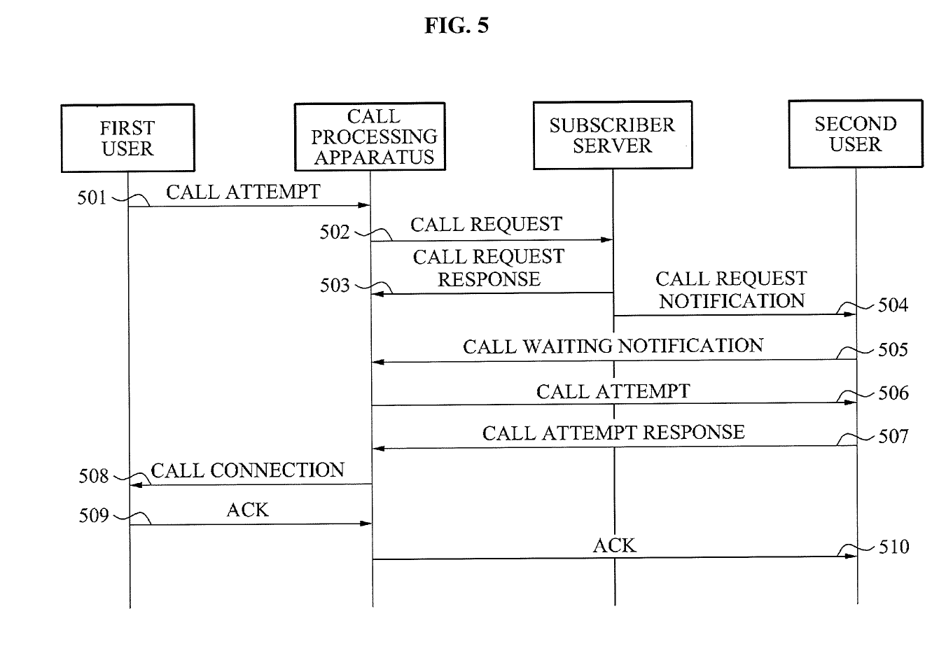

Hereinafter, a detailed description of the subscriber server receiving the call connection request from the call processing apparatus is provided with reference to FIG. 5. In operation 501, the call processing apparatus may receive a call attempt from the first user terminal. Since the first user terminal is a non-mVoIP subscriber, the call processing apparatus may receive the call attempt in a form of a message through a separate interconnecting device, for example, an SSW. The received call attempt may correspond to a call attempt message routed using an identification number of a subscriber.

Since the first user terminal as a caller transmitting the call request is a non-mVoIP subscriber, the call request message between the first user terminal and the subscriber server may be processed through the call processing apparatus receiving a call via an external network, for example, PSTN/PLMN.

In operation 502, the call request may be processed by the call processing apparatus, and notification of the call request may be provided by the subscriber server in operation 504. That is, the call processing apparatus may transmit, to the subscriber server, the call request associated with the call attempt from the first user terminal in operation 502, and the subscriber server may transmit a response to the call request to the call processing apparatus in operation 503, and may transmit a call request notification to the second user terminal as a called party in operation 504. In this instance, the call processing apparatus may defer transmitting the call attempt until the call processing apparatus receives a call waiting notification providing notification of a ready state from the second user terminal in operation 505. When the call processing apparatus receives the call waiting notification in operation 505, the call processing apparatus may transmit the call attempt received from the first user terminal to the second user terminal through an interconnecting device. Here, the call waiting notification of the second user terminal may be implemented by executing registration of user information in a register on the call processing apparatus.

For continuity of a service, it is inevitable for an mVoIP subscriber to execute a periodic registration of user information in a register. However, similar to FIG. 3, the method of FIG. 5 may omit periodic registration of user information in a register by providing a call request notification to a called party through a channel connected to a subscriber, for example, an MIM service and an SNS, other than a call processing channel, and may eliminate the need for the call processing apparatus to store subscriber information.

Subsequently, the call processing apparatus may transmit the deferred call attempt transmitted from the first user terminal to the second user terminal as a called party in operation 506, may receive a response to the call attempt in operation 507, and may establish a call connection between the first user terminal and the second user terminal in operation 508. Also, the call processing apparatus may receive, from the first user terminal, an ACK signal indicating that the call connection is completed without a data error in operation 509, and may transmit the ACK signal to the second user terminal in operation 510. The call connecting method may end. The communication with the first user terminal may be implemented by connecting to an external communication network, for example, PSTN/PLMN, through an interconnecting device, for example, an SSW.

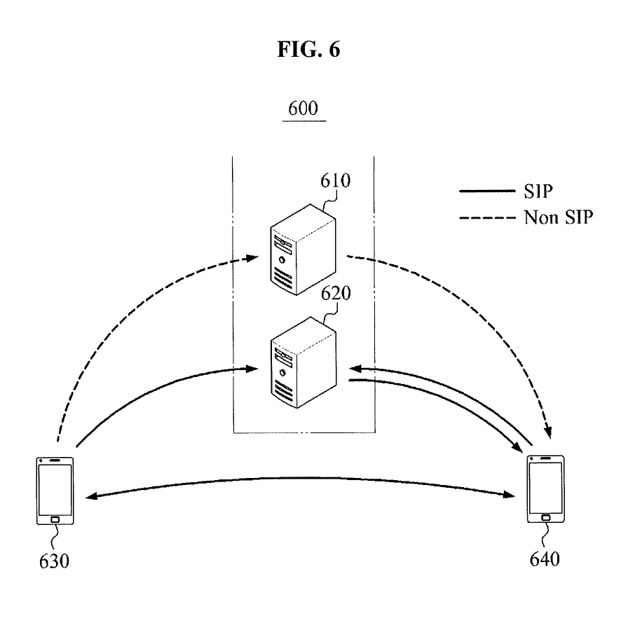

FIG. 6 is a diagram illustrating the system of FIG. 3.

Referring to FIG. 6, a system 600 for connecting a call based on mVoIP may include a subscriber server 610 and a call processing apparatus 620. The subscriber server 610 may receive, from a first user terminal 630, a call connection request to a second user terminal 640 and may provide notification of the received call connection request to the second user terminal 640. The call processing apparatus 620 may receive a call attempt message from the first user terminal 630, may receive a call waiting notification providing notification of a ready state from the second user terminal 640, and may establish a call connection between the first user terminal 630 and the second user terminal 640 by transmitting the call attempt message to the second user terminal 640. The system 600 may correspond to the system performing the call connecting method of FIG. 3, and the subscriber server 610 may correspond to the subscriber server of FIG. 2.

As shown in FIG. 6, since the operations performed through the subscriber server 610 are related to user information, a TCP connection may be maintained using a non-SIP to resolve an issue associated with poor security. Also, a binary encoded message may be transmitted and received between the user terminal and the subscriber server 610, which may be favorable in terms of capacity and security. The operations in the system 600 through the call processing apparatus 620 may be performed using an SIP as conventionally.

According to the call connecting system 600 following the embodiment of FIG. 3, the call processing apparatus 620 may defer transmitting the received call attempt message to the second user terminal 640 until the call processing apparatus 620 receives the call waiting notification providing notification of the ready state from the second user terminal 640. The system 600 may be implemented by maintaining user state information in the subscriber server 610 in lieu of periodic registration of user information in a register. When the call is terminated, the user terminal may transmit an SIP registration release request through an SIP register message, and registration on the subscriber server 610 may be updated using a non-SIP message periodically.

The call connecting system according to this exemplary embodiment may include a feature in that notification of the call request may be provided to a user participating in call connection through a separate channel, other than an existing call processing channel, and user information may be absent in the call processing apparatus 620 according to the present invention. The separate channel may include an MIM service and an SNS. Also, the separate channel may include a channel connected to the user to provide the user with a service.

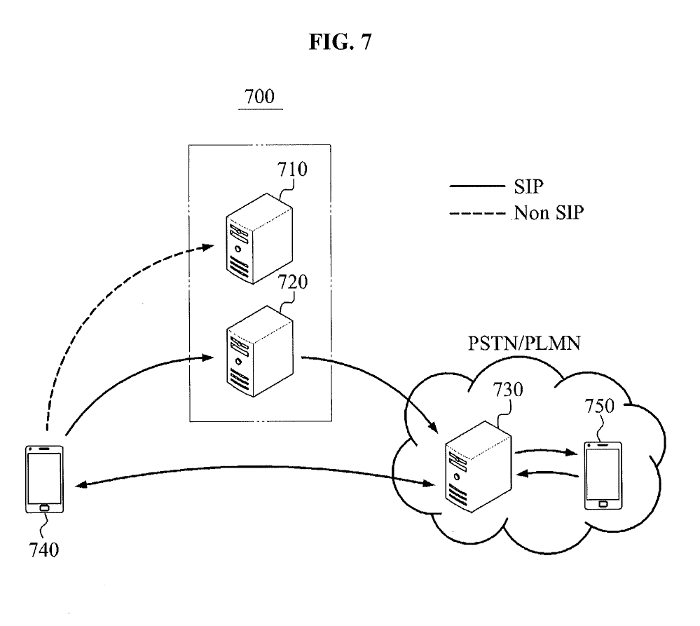

FIG. 7 is a diagram illustrating the system of FIG. 4.

Referring to FIG. 7, a system 700 for connecting a call based on mVoIP according to another exemplary embodiment may perform the call connecting method of FIG. 4. The system 700 may include a subscriber server 710 and a call processing apparatus 720. The subscriber server 710 may receive, from a first user terminal 740, a call connection request to a second user terminal 750 and may transmit a response to the received call connection request. The call processing apparatus 720 may receive a call attempt message from the first user terminal 740, and may establish a call connection between the first user terminal 740 and the second user terminal 750 by transmitting the received call attempt message to the second user terminal 750.

The call connecting system 750 may be applied to a case in which the first user terminal 740 is an mVoIP subscriber and the second user terminal 750 is a non-mVoIP subscriber, and the subscriber server 710 may transmit a response message indicating that the second user terminal 750 is a non-subscriber, to the first user terminal 740 in response to the received call connection request, and the second user terminal 750 may be connected to PSTN/PLMN. Accordingly, a call connection may be established between the first user terminal 740 and the second user terminal 750. That is, the communication with the second user terminal 750 may be implemented by connecting to an external communication network, for example, PSTN/PLMN, through an interconnecting device, for example, an SSW.

Also, when the call processing apparatus 720 transmits the call attempt message to the second user terminal 750, the call processing apparatus 720 may transmit the call attempt message to the second user terminal 750 by connecting to PSTN/PLMN using an interconnecting device 730 through routing by using a telephone number of the second user terminal 750.

The call connecting system 700 according to this exemplary embodiment may allow a call connection with a wired communication subscriber as well as a mobile communication subscriber since the method is based on a relatively low-cost mVoIP, in lieu of a costly mobile communication, using a telephone number of a user.

Since the operations performed through the subscriber server 710 are related to user information, a TCP connection may be maintained using a non-SIP to resolve an issue associated with poor security. Also, a binary encoded message may be transmitted and received between the user terminal and the subscriber server 710, which may be favorable in terms of capacity and security. The operations in the system 600 through the call processing apparatus 720 may be performed using a conventional SIP.

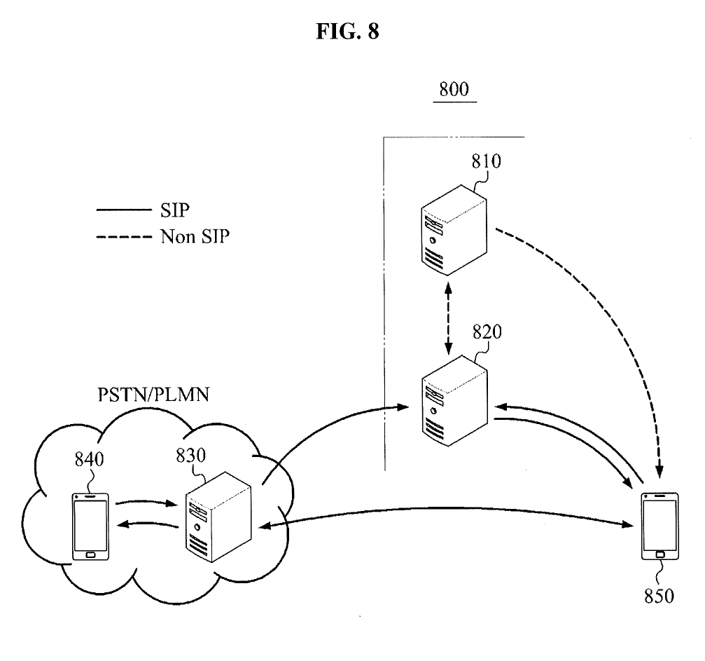

FIG. 8 is a diagram illustrating the system of FIG. 5

Referring to FIG. 8, a system 800 for connecting a call based on mVoIP according to still another exemplary embodiment may perform the call connecting method of FIG. 5. The system 800 may include a subscriber server 810 and a call processing apparatus 820. The subscriber server 810 may receive a call attempt message also routed using an identification number of an mVoIP subscriber through an interconnecting device 830. Also, the subscriber server 710 may receive a call connection request from the call processing apparatus 820. The call processing apparatus 820 may receive a call waiting notification providing notification of a ready state from the second user terminal 850, and may establish a call connection between the first user terminal 840 and the second user terminal 850 by transmitting the received call attempt message to the second user terminal 850.

In this instance, the embodiment of FIG. 8 may be applied to a case in which the first user terminal 840 is a non-mVoIP subscriber and the second user terminal 850 is an mVoIP subscriber, and the subscriber server 810 may receive the call request from the call processing apparatus 820 using information about the second user terminal 850. That is, the call processing apparatus 820 may transmit the call connection request to the subscriber server 810 using information about the second user terminal 850 as an mVoIP subscriber.

Also, the call processing apparatus 820 may defer transmitting the received call attempt message until the call processing apparatus 820 receives the call waiting notification providing notification of the ready state from the second user terminal 850, and when the call processing apparatus 820 receives the call waiting notification, the call processing apparatus 820 may transmit the received call attempt message to the second user terminal 850 so that a successful call connection may be established between the first user terminal 840 and the second user terminal 850. In the call connecting system 800, all the communications with the first user terminal 840 as a non-subscriber, the call request, and the call request notification may be implemented by connecting to an external communication network, for example, PSTN/PLMN, through the interconnecting device 830, for example, an SSW.

Furthermore, as shown in FIG. 8, the operations performed through the subscriber server 810 may be performed by maintaining a TCP connection using a non-SIP. Also, a binary encoded message may be transmitted and received between the user terminals 840 and 850 and the subscriber server 810, which may be favorable in terms of capacity and security. The operations in the system 600 through the call processing apparatus 820 may be performed using a conventional SIP.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard discs, floppy discs, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Based on the fact that a service provided with a channel for transmitting information to subscribers, for example, an MIM service and an SNS, have a function for executing a registration procedure identical or similar to that of VoIP, the method and system for connecting a call on mVoIP according to the exemplary embodiments may reduce a load generated due to periodic registration of user information in a register, may improve the entire system perform, and may ease the management of the system.

Also, use of a separately defined message may improve security.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of connecting a call based on mobile Voice over Internet Protocol (mVoIP) performed in a system for connecting a call based on mVoIP comprising a subscriber server and a call processing apparatus, the method comprising:
receiving a call connection request to a second user terminal, by the subscriber server, from a first user terminal and providing notification of the received call connection request to the second user terminal;
receiving a call attempt message, by the call processing apparatus, from the first user terminal;
receiving a call waiting notification, by the call processing apparatus, providing notification of a ready state from the second user terminal; and
establishing, by the call processing apparatus, a call connection between the first user terminal and the second user terminal by transmitting the received call attempt message to the second user terminal.

2. The method of claim 1, wherein the transmitting of the call attempt message is deferred until the call waiting notification providing notification of the ready state from the second user terminal is received by the call processing apparatus.

3. The method of claim 1, wherein the notification of the call connection request is provided to a user participating in the call connection through a separate channel other than a call processing channel of the call connecting method, and
user information is absent in the call processing apparatus.

4. The method of claim 3, wherein the separate channel includes a mobile instant messaging (MIM) service and a social networking service (SNS), and is connected to the user.

5. A method of connecting a call based on mobile Voice over Internet Protocol (mVoIP) performed in a system for connecting a call based on mVoIP comprising a subscriber server and a call processing apparatus, the method comprising:
receiving a call connection request to a second user terminal, by the subscriber server, from a first user terminal and transmitting a response to the received call connection request;
receiving a call attempt message, by the call processing apparatus, from the first user terminal; and
establishing, by the call processing apparatus, a call connection between the first user terminal and the second user terminal by transmitting the received call attempt message to the second user terminal.

6. The method of claim 5, wherein in a case in which the first user terminal is an mVoIP subscriber and the second user terminal is a non-mVoIP subscriber,
the receiving of the call connection request to the second user terminal, by the subscriber server, from the first user terminal and transmitting the response to the received call connection request comprises:
transmitting to the first user terminal, by the subscriber server, a response message indicating that the second user terminal is a non-subscriber, in response to the received call connection request, and
the call connection is established by connecting the second user terminal to a public switched telephone network/public land mobile network (PSTN/PLMN).

7. The method of claim 5, wherein the transmitting of the received call attempt message, by the call processing apparatus, to the second user terminal comprises transmitting, by the call processing apparatus, the received call attempt message by connecting to the PSTN/PLMN through routing by using a telephone number of the second user terminal.

8. A method of connecting a call based on mobile Voice over Internet Protocol (mVoIP) performed in a system for connecting a call based on mVoIP comprising a subscriber server and a call processing apparatus, the method comprising:
receiving a call attempt message, by the call processing apparatus, also routed using an identification number of an mVoIP subscriber through an interconnecting device;
receiving a call connection request, by the subscriber server, from the call processing apparatus;
receiving a call waiting notification, by the call processing apparatus, providing notification of a ready state from the second user terminal; and
establishing, by the call processing apparatus, a call connection between the first user terminal and the second user terminal by transmitting the received call attempt message to the second user terminal.

9. The method of claim 8, wherein in a case in which the first user terminal is a non-mVoIP subscriber and the second user terminal is an mVoIP subscriber,
the receiving of the call connection request, by the subscriber server, from the call processing apparatus comprises:
receiving the call connection request, by the subscriber server, from the call processing apparatus using information about the second user terminal.

10. The method of claim 8, wherein the transmitting of the received call attempt message is deferred until the call waiting notification providing notification of the ready state from the second user terminal is received by the call processing apparatus.

11. A system for connecting a call based on mobile Voice over Internet Protocol (mVoIP), the system comprising:
a subscriber server; and
a call processing apparatus, and
wherein the subscriber server receives, from a first user terminal, a call connection request to a second user terminal and provides notification of the received call connection request to the second user terminal,
the call processing apparatus receives a call attempt message from the first user terminal,
the call processing apparatus receives a call waiting notification providing notification of a ready state from the second user terminal, and
the call processing apparatus establishes a call connection between the first user terminal and the second user terminal by transmitting the received call attempt message to the second user terminal.

12. The system of claim 11, wherein the call processing apparatus defers transmitting of the received call attempt message until the call processing apparatus receives the call waiting notification providing notification of the ready state from the second user terminal.

13. The system of claim 11, wherein the notification of the call connection request is provided to a user participating in the call connection through a separate channel other than a call processing channel of the call connecting system, and
user information is absent in the call processing apparatus.

14. The system of claim 13, wherein the separate channel includes a mobile instant messaging (MIM) service and a social networking service (SNS), and is connected to the user.

15. A system for connecting a call based on mobile Voice over Internet Protocol (mVoIP), the system comprising:
a subscriber server; and
a call processing apparatus,
wherein the subscriber server receives, from a first user terminal, a call connection request to a second user terminal and transmits a response to the received call connection request,
the call processing apparatus receives a call attempt message from the first user terminal, and
the call processing apparatus establishes a call connection between the first user terminal and the second user terminal by transmitting the received call attempt message to the second user terminal.

16. The system of claim 15, wherein in a case in which the first user terminal is an mVoIP subscriber and the second user terminal is a non-mVoIP subscriber,
the subscriber server transmits a response message indicating that the second user terminal is a non-subscriber to the first user terminal in response to the received call connection request, and
the call processing apparatus establishes the call connection by connecting the second user terminal to a public switched telephone network/public land mobile network (PSTN/PLMN).

17. The system of claim 15, wherein when the call processing apparatus transmits the call attempt message to the second user terminal, the call processing apparatus transmits the call attempt message by connecting to the PSTN/PLMN through routing by using a telephone number of the second user terminal.

18. A system for connecting a call based on mobile Voice over Internet Protocol (mVoIP), the system comprising:
a subscriber server; and
a call processing apparatus,
wherein the call processing apparatus receives a call attempt message also routed using an identification number of an mVoIP subscriber through an interconnecting device;
the subscriber server receives a call connection request from the call processing apparatus,
the call processing apparatus receives a call waiting notification providing notification of a ready state from the second user terminal, and
the call processing apparatus establishes a call connection between the first user terminal and the second user terminal by transmitting the received call attempt message to the second user terminal.

19. The system of claim 18, wherein in a case in which the first user terminal is a non-mVoIP subscriber and the second user terminal is an mVoIP subscriber,
the subscriber server receives the call connection request from the call processing apparatus using information about the second user terminal.

20. The system of claim 18, wherein the call processing apparatus defers transmitting the received call attempt message until the call processing apparatus receives the call waiting notification providing notification of the ready state from the second user terminal.
